(19) United States
(12) Patent Application Publication
(10) Pub. No.: US 2015/0070399 A1
(43) Pub. Date: Mar. 12, 2015

(54) Managing Partially Out-of-Frame View Areas

(71) Applicant: Apple Inc., Cupertino, CA (US)

(72) Inventor: David B. Kosecoff, San Francisco, CA (US)

(21) Appl. No.: 14/020,981

(22) Filed: Sep. 9, 2013

(51) Int. Cl. G09G 5/34

(52) U.S. Cl. CPC G09G 5/34
USPC 345/684

(57) ABSTRACT

Systems, methods and computer-readable mediums are disclosed for displaying visible scroll bars for scrolling out-of-frame view areas. In some implementations, scrollbars of a view area are revealed when the user is scrolling the view area and the view area is partially out-of-frame. In some implementations, one or more objects in a view area are repositioned in the view area when the view area is partially out-of-frame.

### TECHNICAL FIELD

This disclosure is related generally to managing view areas for graphical user interfaces.

### BACKGROUND

A scrollbar is an object in a graphical user interface (GUI) with which content displayed in a view area (e.g., window, viewport) can be scrolled. Scrollbars are usually displayed on one or two sides of the view area as a long rectangular area (“track”) containing a bar (“scroller”). The scroller can be dragged by a user along the track to reveal content displayed in the view area.

Scroll bars are often displayed on the right edge and bottom edge of the view area when the view area is active. However, if the view area is located partially out of the display frame, the user must drag the entire view area back into the display frame to move the scroller, which can disrupt the workflow of the user.

### SUMMARY

Systems, methods and computer-readable mediums are disclosed for displaying visible scroll bars for scrolling out-of-frame view areas. In some implementations, scrollbars of a view area are revealed when the user is scrolling the view area and the view area is partially out-of-frame. In some implementations, one or more objects in a view area are repositioned in the view area when the view area is partially out-of-frame.

In some implementations, a method comprises: displaying a graphical user interface in a display frame of a device; displaying a view area in the graphical user interface; determining that a portion of the view area is partially within the display frame; and responsive to the determining, revealing a scrollbar for scrolling contents in the view area, the scrollbar located along an edge of the display frame where the view area extends outside the display frame.

In some implementations, a method comprises: displaying a graphical user interface in a display frame of a device; displaying a view area in the graphical user interface; determining that a portion of a view area is partially within a display frame; and responsive to the determining, displaying the scrollbar along a first side of the view area that is within the display frame, the first side opposite a second side of the view area that is not within the display frame.

In some implementations, a method comprises: displaying a graphical user interface in a display frame of a device; displaying a view area in the graphical user interface; determining that a portion of the view area is partially within the display frame; and responsive to the determining, repositioning an object in the view area.

Other implementations are directed to systems, computer program products, and computer-readable mediums.

Particular implementations disclosed herein provide one or more of the following advantages. A user does not have to drag an entire view area into a display frame to activate a scrollbar or to see objects in the view area.

The details of the disclosed implementations are set forth in the accompanying drawings and the description below. Other features, objects, and advantages will be apparent from the description and drawings, and from the claims.

DESCRIPTION OF DRAWINGS

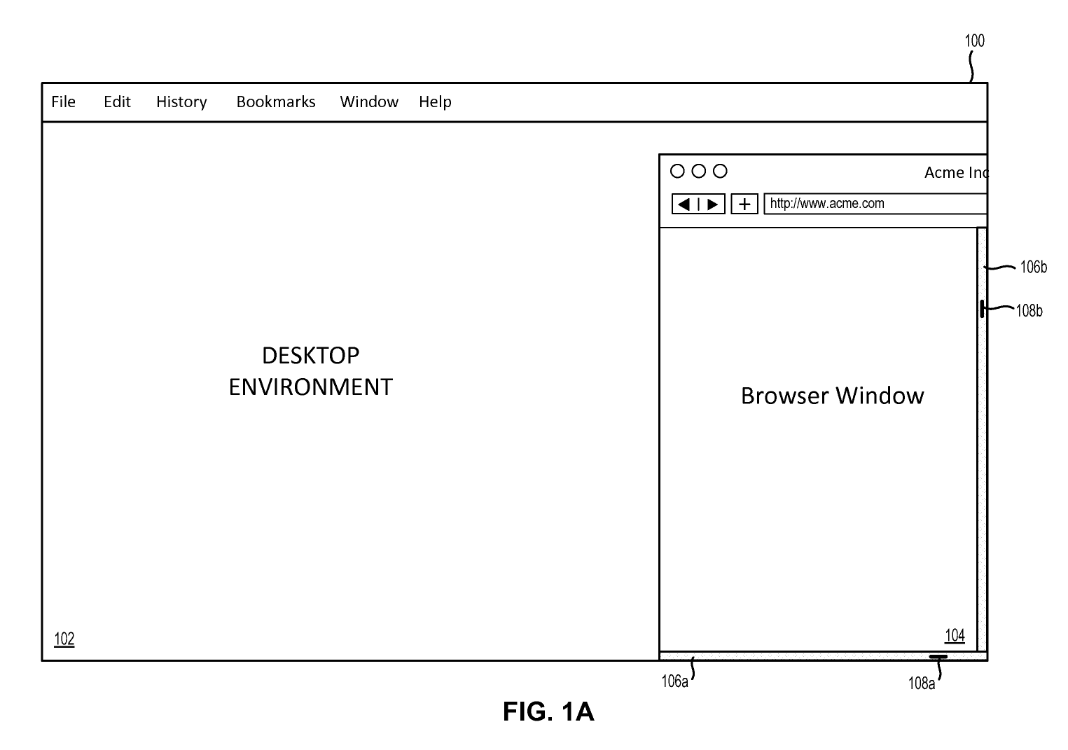

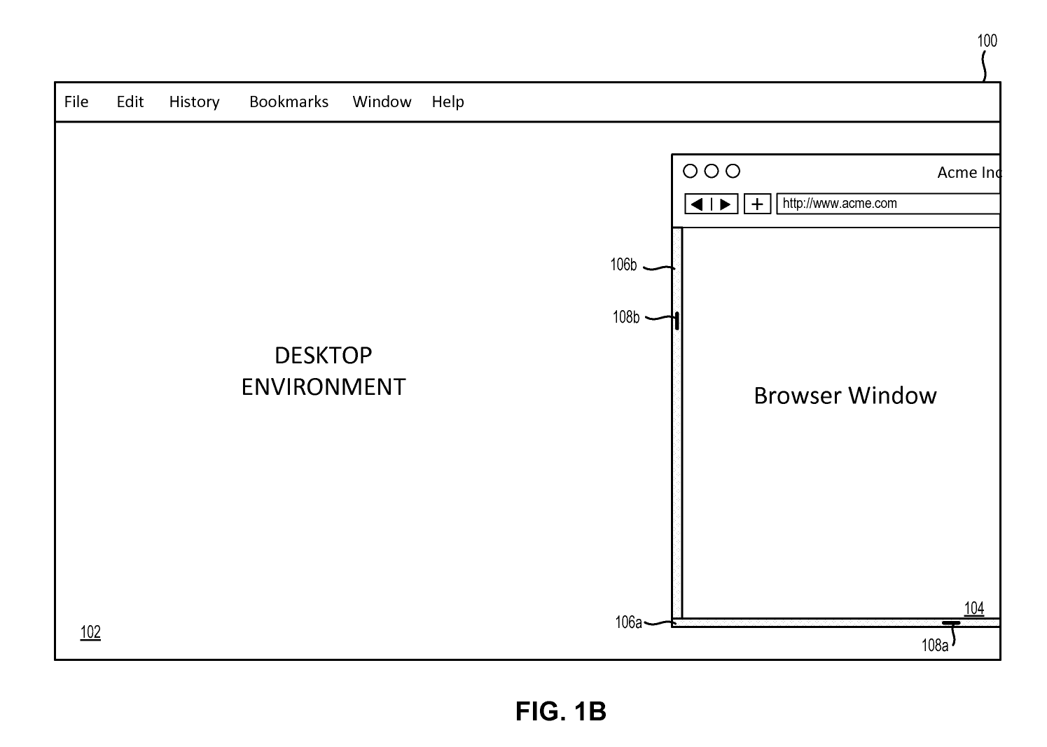

FIGS. 1A and 1B illustrate examples of visible scrollbars for partially out-of-frame view areas.

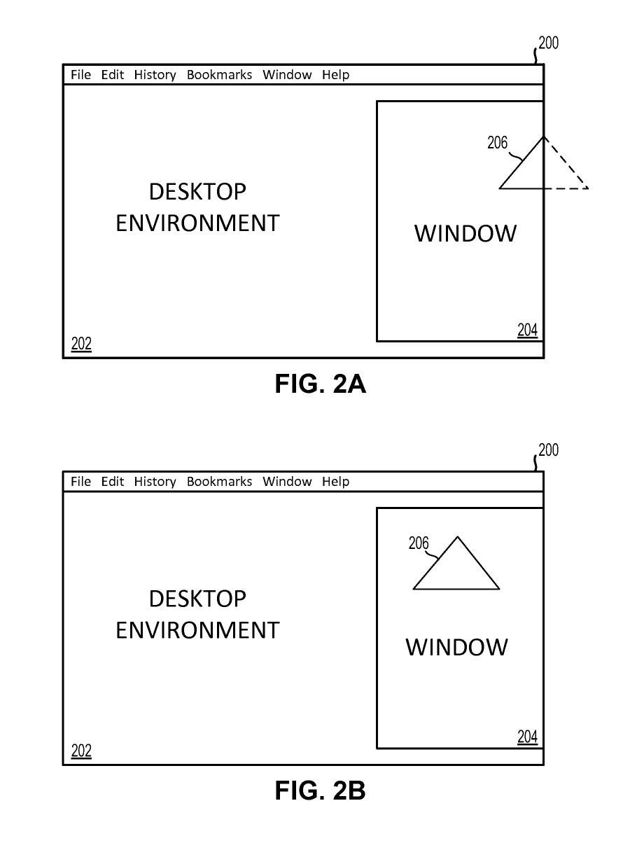

FIGS. 2A and 2B illustrate the repositioning of an object in a partially out-of-frame view area.

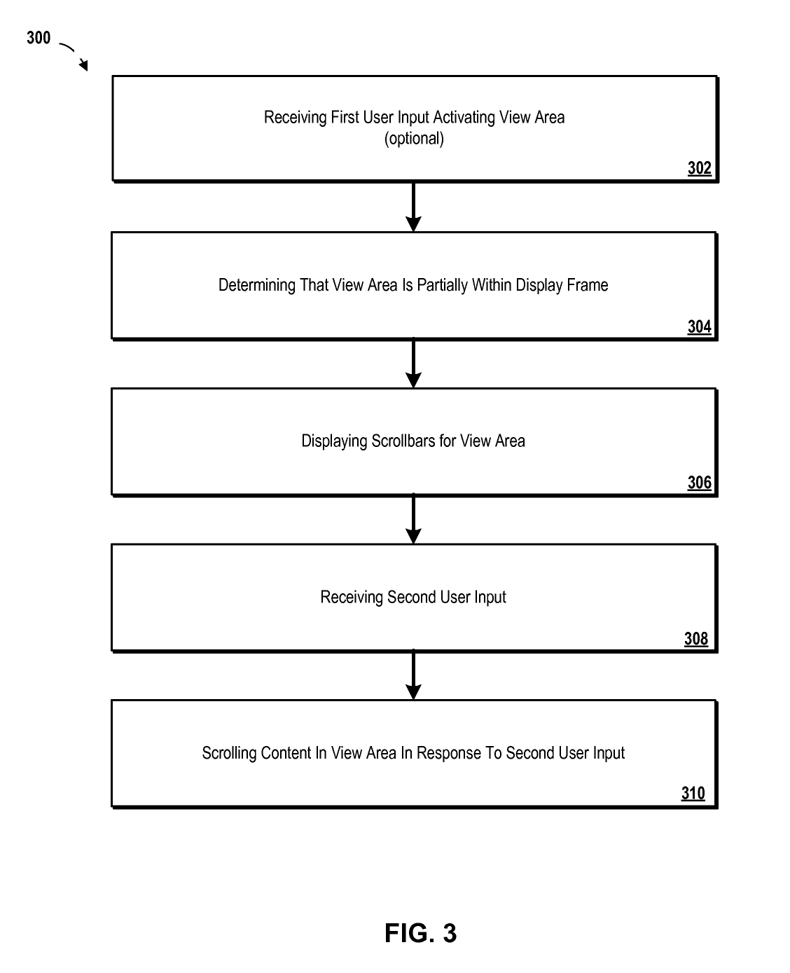

FIG. 3 is a flow diagram of an example process for displaying visible scrollbars for partially out-of-frame view areas.

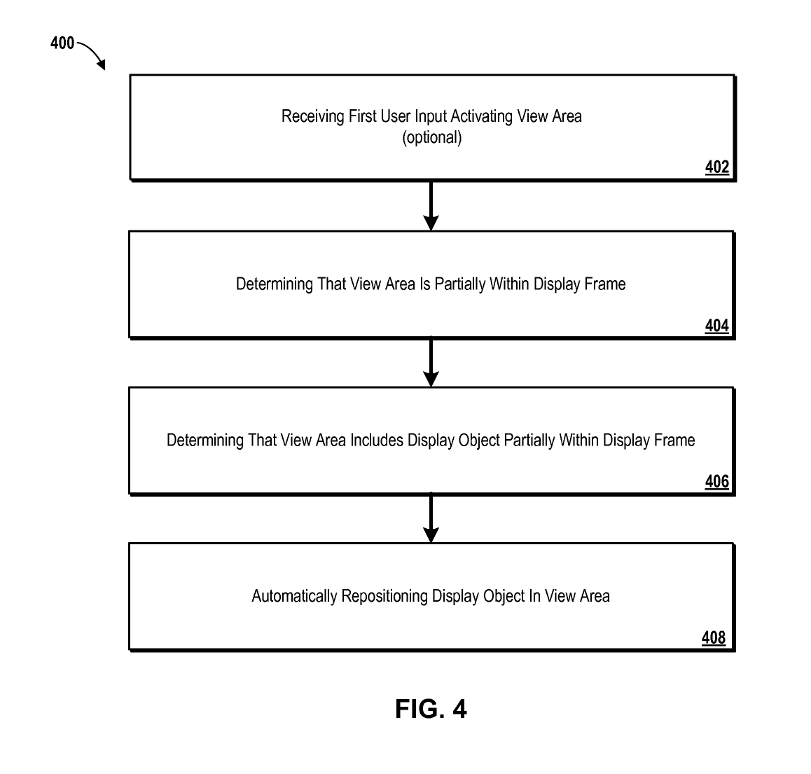

FIG. 4 is a flow diagram of an example process for repositioning objects in partially out-of-frame view areas.

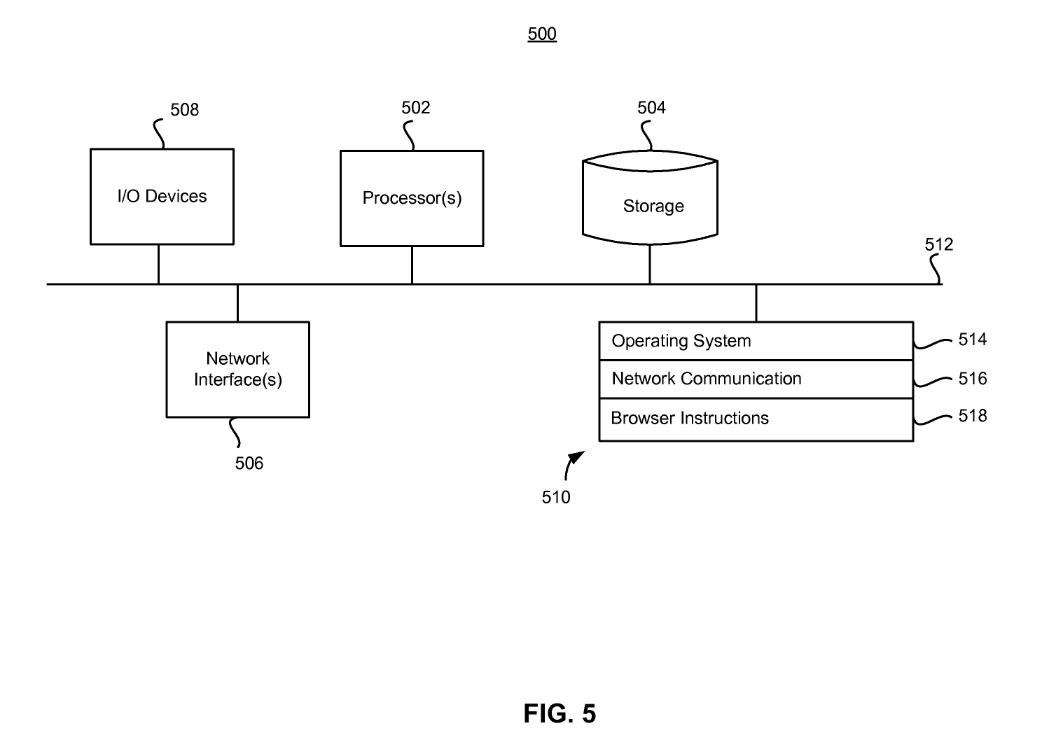

FIG. 5 is a block diagram of example architecture for a device capable of implementing the features and processes described in reference to FIGS. 1-4.

The same reference symbol used in various drawings indicates like elements.

### DETAILED DESCRIPTION

### Exemplary Graphical User Interfaces

FIG. 1A illustrates an example of visible scrollbars for partially out-of-frame view areas. In some implementations, a view area can be a window. A window can be managed by a window manager. A window manager is system software that controls the placement and appearance of windows within a GUI generated by a windowing system. A windowing system implements graphical primitives, including rendering fonts or drawing a line on a display screen. A windowing system can be part of a computer operating system, such as Mac OS® developed by Apple Inc. of Cupertino, Calif. U.S.A., or can be provided by an application.

In some implementations, a window manager generates GUI 100 using an underlying graphical system that provides support for graphics hardware and pointing devices (e.g., mouse, keyboard) including support for processing touch-input and gestures on touch-sensitive displays or surfaces (e.g., a touch pad). GUI 100 can provide a desktop environment based on a desktop metaphor. In the example shown, browser window 104 is opened in GUI 100 and located partially within display frame 102.

In the example shown, scrollbar 106b is located along the right edge of display frame 102 and scrollbar 106a is located along the bottom edge of display frame 102. The directional references left, right, top and bottom of display frame 102 are assumed to be from the perspective of a user facing display frame 102. Generally, a display frame is the area of a display device (e.g., a display screen) in which a view area (e.g., window, viewport) is visible to the user.

Scrollbars 106a, 106b include scrollers 108a, 108b, respectively. A user can scroll the contents in window 104 by moving scrollers 108a, 108b. In some implementations, scrollbars 106a, 106b are not revealed until browser window 104 is activated. Browser window 104 can be activated when the user “hovers” over browser window 104 with a cursor or other pointer, or otherwise interacts with browser window 104 (e.g. clicks on browser window). In other implementations, scrollbars 106a, 106b are revealed automatically when a windows manager detects that browser window 104 is partially within display frame 102.

Scrollbar 106a includes a rectangular track portion and scroller 108a. Scrollbar 106b includes a rectangular track portion and scroller 108b. In some implementations, the length of a track for a scrollbar can be coextensive with the portion of a edge of a view area that is within the display frame. In such implementations, the length of the track allows all the contents (e.g., a web page or other document) of the view area to be scrolled. In the example shown, scrollbar 106a is displayed along the bottom edge of browser window 104 and has a track length that is coextensive with the portion of the bottom edge of browser window 104 that is within display frame 102. A user can move scroller 108a along the track to expose previously unexposed content in browser window 104.

FIG. 1B illustrates another example of visible scrollbars for partially out-of-frame view areas. In this example, the right edge of browser window 104 is located outside display frame 102 and the bottom edge of browser window 104 is located within display frame 102. In this implementation, scrollbar 106a is displayed at the bottom edge of browser window 104, rather than the bottom edge of display frame 102, and has a track length that is coextensive with the portion of the bottom edge of browser window 104 that is within display frame 102. Additionally, scrollbar 106b is displayed at the left edge of browser window 104. Thus, in some implementation a scrollbar can be displayed along a first edge (e.g., left side) of a view area and opposite a second edge (e.g., right edge) of the view area that extends outside the display frame.

FIGS. 2A and 2B illustrate the repositioning of an object in a partially out-of-frame view area. Referring to FIG. 2A, view area 204 (e.g., a browser window) is partially out of display frame 202 such that object 206 is partially obfuscated (as indicated by the dashed lines outside display frame 202).

Referring to FIG. 2B, when view area 204 is determined (e.g., by a window manager) to be partially out of display frame 202, object 206 is repositioned in view area 204 to reveal all or more of object 206 to the user. In some implementations, object 206 can be repositioned to a predefined location within the visible portion of view area 204 inside display frame 202.

In some implementations, object 206 can be dynamically resized in addition to being repositioned in view area 204. If other objects are at least partially within the visible portion of view area 204, those objects can also be repositioned or resized as necessary to ensure that all of the objects in view area 204 are at least partially displayed in the visible portion of view area 204. By knowing the dimensions of view area 204, display frame 202 and object 206, a windows manager or windowing system can determine whether object 206 is partially obfuscated. The windows manager or windowing system can then determine a new location in the visible portion of view area 204 to redraw the object and whether a dynamic resizing of object 206 is necessary.

### Exemplary Processes

FIG. 3 is a flow diagram of an example process 300 for displaying visible scrollbars for partially out-of-frame view areas. Process 300 can be implemented by architecture 500 as described in reference to FIG. 5.

In some implementations, process 300 can begin by optionally receiving first user input activating a view area (302). For example, to activate the view area, the user can “hover” over the view area with a cursor or other pointer or otherwise interact with the view area (e.g., click on the view area).

Process 300 can continue by determining that the view area is partially within the display frame (304) and then displaying scrollbars for the view area (306). For example, the window manager or windowing system can determine if a portion of the view area is partially within the display frame; and responsive to the determining, reveal a scrollbar for scrolling contents in the view area. In some implementations, the scrollbar can be located along an edge of the display frame where the view area extends outside the display frame. The scrollbar can be coextensive with the edge of the view area, or longer or shorter.

In some implementations, the window manager or windowing system can determine the length and placement of the scrollbar based on the current size of the view area and the position of the view area in a reference coordinate system. The reference coordinate system for a view area can be based on the coordinate system of the display frame, which can be the same as the coordinate system of the display device (e.g., screen coordinates). The basic unit of measure can be a pixel. Points in the display frame can be described by x- and y-coordinate pairs, where the x-coordinates increase from left to right and y-coordinates increase from top to bottom of the display frame. The origin (0, 0) for the coordinate system depends on the type of coordinates being used.

In some implementations, the window manager or windowing system specifies the position of a view area in the display frame, which can be in display screen coordinates. For display screen coordinates, the origin can be the upper-left corner of the display screen. The full position of a view area can be described by a data structure containing the display screen coordinates of the two points that define the upper-left and lower-right corners of the view area. The window manager or windowing system can specify the position of points within a view area by using a second pair of coordinates (“client coordinates”), where the origin is the upper-left corner of the view area. The dimensions of the view area can also be described by a data structure that contains the second pair of coordinates for the view area.

In other implementations, the scrollbar can be displayed along a first side (e.g., left side) of the view area that is opposite a second side (e.g., rights side) of the view area that is not within the display frame. The window manager or windowing system can determine the length and placement of the scrollbar based on the current size of the view area and the position coordinates of the view area within the display frame or screen coordinates.

Process 300 can continue by receiving second user input (308) and scrolling content in the view area in response to the second user input (310). For example, the user can move a scroller of the scrollbar to expose contents in the view area that were previously unexposed. In some implementations, the length of a track for a scrollbar can be coextensive with the edge of a view area that is within the display frame. In such implementations, the length of the track allows all the contents (e.g., a web page or other document) of the view area to be scrolled.

FIG. 4 is a flow diagram of an example process 400 for repositioning objects in partially out-of-frame view areas. Process 400 can be implemented by architecture 500 as described in reference to FIG. 5.

In some implementations, process 400 can begin by optionally receiving a first user input activating a view area (402). For example, to activate the view area, the user can “hover” over the view area with a cursor or other pointer or otherwise interact with the view area (e.g., click on the view area).

Process 400 can continue by determining that the view area is partially within the display frame (404) and that the view area includes an object that is partially within the display frame (406). Process 400 can then automatically reposition the object in the view area.

In some implementations, the object can be dynamically resized in addition to being repositioned in the view area. If other objects are at least partially within the visible portion of the view area, those objects can also be repositioned or resized as necessary to ensure that all of the objects in view area are at least partially displayed in the visible portion of view area. By knowing the dimensions of the view area, the display frame and the object, a windows manager or windowing system can determine whether the object is partially obfuscated. The windows manager or windowing system can then determine a new location in the visible portion of the view area to redraw the object and whether a dynamic resizing of the object is necessary.

### Exemplary Device Architecture

FIG. 5 is a block diagram of example architecture for a device capable of implementing the features and processes described in reference to FIGS. 1-4. Architecture 500 may be implemented on any data processing apparatus that runs software applications derived from instructions, including without limitation personal computers, smart phones, electronic tablets, game consoles, servers or mainframe computers. In some implementations, the architecture 500 may include processor(s) 502, storage device(s) 504, network interfaces 506, Input/Output (I/O) devices 508 and computer-readable medium 510 (e.g., memory). Each of these components may be coupled by one or more communication channels 512.

Communication channels 512 may be any known internal or external bus technology, including but not limited to ISA, EISA, PCI, PCI Express, NuBus, USB, Serial ATA or FireWire.

Storage device(s) 504 may be any medium that participates in providing instructions to processor(s) 502 for execution, including without limitation, non-volatile storage media (e.g., optical disks, magnetic disks, flash drives, etc.) or volatile media (e.g., SDRAM, ROM, etc.).

I/O devices 508 may include displays (e.g., touch sensitive displays), keyboards, control devices (e.g., mouse, buttons, scroll wheel), loud speakers, audio jack for headphones, microphones and another device that may be used to input or output information.

Computer-readable medium 510 may include various instructions 514 for implementing an operating system (e.g., Mac OS®, Windows®, Linux). The operating system may be multi-user, multiprocessing, multitasking, multithreading, real-time and the like. The operating system performs basic tasks, including but not limited to: keeping track of files and directories on storage devices(s) 504; controlling peripheral devices, which may be controlled directly or through an I/O controller; and managing traffic on communication channels 512. In some implementations, instructions 514 can include instructions for implementing a windows manager or windowing system as described in reference to FIGS. 1-4. In other implementations, the window manager or windowing system can be implemented separate from the operating system, such as being implemented by an application.

Network communications instructions 516 may establish and maintain network connections with client devices (e.g., software for implementing transport protocols, such as TCP/IP, RTSP, MMS, ADTS, HTTP Live Streaming). Computer-readable medium 510 may store instructions, which, when executed by processor(s) 502 implement browser instructions 518 for generating browser windows as described in reference to FIGS. 1-4.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). For example, the data access daemon may be accessed by another application (e.g., a notes application) using an API. An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
displaying a graphical user interface in a display frame of a device;
displaying a view area in the graphical user interface;
determining that a portion of the view area is partially within the display frame; and
responsive to the determining, revealing a scrollbar for scrolling contents in the view area, the scrollbar located along an edge of the display frame where the view area extends outside the display frame,
where the method is performed by one or more hardware processors.

2. The method of claim 1, where the scrollbar includes a track and a scroller, the scroller is movable within the track and the length of track allows for all the contents in the view area to be scrolled using the scroller.

3. The method of claim 1, further comprising:
receiving user input activating the view area prior to displaying the scrollbar.

4. The method of claim 1, where revealing the scrollbar further comprises:
displaying the entire scrollbar in the portion of the view area that is within the display frame.

5. The method of claim 1, where the view area is a browser window.

6. A method comprising:
displaying a graphical user interface in a display frame of a device;
displaying a view area in the graphical user interface;
determining that a portion of a view area is partially within a display frame; and
responsive to the determining, displaying the scrollbar along a first side of the view area that is within the display frame, the first side opposite a second side of the view area that is not within the display frame,
where the method is performed by one or more hardware processors.

7. The method of claim 6, where revealing the scrollbar further comprises:
displaying the entire scrollbar in the view area that is within the display frame.

8. The method of claim 6, where the scrollbar includes a track and a scroller, the scroller is movable within the track and the length of track allows for all the contents in the view area to be scrolled using the scroller.

9. The method of claim 6, further comprising:
receiving user input activating the view area prior to revealing the scrollbar.

10. The method of claim 6, where the view area is a browser window.

11. A system comprising:
one or more processors;
memory coupled to the one or more processors and configured to store instructions, which, when executed by the one or more processors, causes the one or more processors to perform operations comprising:
displaying a graphical user interface in a display frame of the system;
displaying a view area is the graphical user interface;
receiving user input activating the view area;
determining that a portion of the view area is partially within the display frame; and
responsive to the determining, revealing a scrollbar for scrolling contents in the view area, the scrollbar located along an edge of the display frame where the view area extends outside the display frame.

12. The system of claim 11, where the scrollbar includes a track and a scroller, the scroller is movable within the track and the length of track allows for all the contents in the view area to be scrolled using the scroller.

13. The system of claim 11, where the instructions, when executed by the one or more processors, causes the one or more processors to perform the operation comprising:
receiving user input activating the view area prior to revealing the scrollbar.

14. The system of claim 11, where revealing the scrollbar further comprises:
displaying the entire scrollbar in the portion of the view area that is within the display frame.

15. The system of claim 11, where the view area is a browser window.

16. A system comprising:
one or more processors;
memory coupled to the one or more processors and configured to store instructions, which, when executed by the one or more processors, causes the one or more processors to perform operations comprising:
displaying a graphical user interface in a display frame of a device;
displaying a view area in the graphical user interface; and
determining that a portion of a view area is partially within a display frame; and responsive to the determining, displaying the scrollbar along a first side of the view area that is within the display frame, the first side opposite a second side of the view area that is not within the display frame.

17. The system of claim 16, where displaying the scrollbar further comprises:
displaying the entire scrollbar in the view area that is within the display frame.

18. The system of claim 16, where the scrollbar includes a track and a scroller, the scroller is movable within the track and the length of track allows for all the contents in the view area to be scrolled using the scroller.

19. The system of claim 16, where the instructions, when executed by the one or more processors, causes the one or more processors to perform the operation comprising:
receiving user input activating the view area prior to displaying the scrollbar.

20. The system of claim 16, where the view area is a browser window.

21. A method comprising:
displaying a graphical user interface in a display frame of a device;
displaying a view area in the graphical user interface;
determining that a portion of the view area is partially within the display frame; and
responsive to the determining, repositioning an object in the view area,
where the method is performed by one or more hardware processors.

22. A system comprising:
one or more processors;
memory coupled to the one or more processors and configured to store instructions, which, when executed by the one or more processors, causes the one or more processors to perform operations comprising:
displaying a graphical user interface in a display frame of a device;
displaying a view area in the graphical user interface;
determining that a portion of the view area is partially within the display frame; and
responsive to the determining, repositioning an object in the view area.
